(19) United States
(12) Patent Application Publication
(10) Pub. No.: US 2012/0328160 A1
(43) Pub. Date: Dec. 27, 2012

(54) METHOD FOR DETECTING AND RECOGNIZING OBJECTS OF AN IMAGE USING HAAR-LIKE FEATURES

(75) Inventors: Kong Kuk Sa, Gyeongsan (KR); Ho Youl Jung, Gyeongsan (KR)

(73) Assignees: Office of Research Cooperation Foundation of Yeungnam University, Gyeongsan (KR); SL CORPORATION, Daegu (KR)

(21) Appl. No.: 13/364,668

(22) Filed: Feb. 2, 2012

(30) Foreign Application Priority Data
Jun. 27, 2011 (KR) 10-2011-0062391

(51) Int. Cl. G06K 9/46

(52) U.S. Cl. 382/107

(57) ABSTRACT

Disclosed is a technique for extracting a Haar-like feature based on moment capable of quickly detecting (or recognizing) an object in an input image by using calculation of the n^{th} moment and the n^{th} central moment using a difference in statistical characteristics of pixel values in the input image, and also provides a method for creating the n^{th} integral image, and a method for calculating the n^{th} moment and a method for calculating the n^{th} central moment using the n^{th} integral image to process the iterations at a high speed using the n^{th} integral image.

### CROSS-REFERENCE TO RELATED APPLICATION

This application claims priority from Korean Patent Application No. 10-2011-0062391 filed on Jun. 27, 2011 in the Korean Intellectual Property Office, and all the benefits accruing therefrom under 35 U.S.C. 119, the contents of which in its entirety are herein incorporated by reference.

### BACKGROUND

1. Field of the Invention

The present invention relates to a method for extracting a Haar-like feature based on moment, which can be applied to detecting (or recognizing) an object in an input image, and more particularly to a method for extracting a Haar-like feature based on moment using a difference in statistical characteristics of pixel values between two or more adjacent blocks in an image.

2. Description of the Related Art

A system for detecting (or recognizing) an object from an image acquired from a camera largely performs two steps, i.e., a feature extraction step for extracting visual feature information related to an object to be detected (recognized) from an image signal inputted from the camera and a step for detecting (or recognizing) an object using the extracted feature. In this case, the step for detecting (or recognizing) an object is performed by a learning method using a learning machine such as AdaBoost or Support Vector Machine (SVM) or a non-learning method using vector similarity of the extracted feature. The learning method and the non-learning method are appropriately selected and used according to the complexity of the background and an object to be detected (or recognized).

However, recently, a Haar-like feature has been applied to the face recognition and vehicle detection field. The Haar-like feature is a local feature related to input images, which is defined as a difference in the sum of pixel values between two or more adjacent blocks. Alternatively, the sum of products of weights may be used as the Haar-like feature. In order to calculate a difference in the sum of pixel values between adjacent blocks, a mask based on a simple rectangular feature is used in extraction of the Haar-like feature.

FIG. 1 illustrates an exemplary diagram showing prototypes of masks used in extraction of a Haar-like feature. Generally, an edge mask, a line mask, a diagonal line mask, and a center surround mask are used as illustrated in FIG. 1. If a white block of FIG. 1 is a block region of group A and a black block of FIG. 1 is a block region of group B, the Haar-like feature is defined by a difference between the sum of pixel values belonging to group A and the sum of pixel values belonging to group B.

The Haar-like feature Hk using the k^{th} mask is defined by the following Eq. 1:

$${H}_{k} = {\sum }_{( x , y ) ∈ A} f ( x , y ) - {\sum }_{( x , y ) ∈ B} f ( x , y ) \qquad Eq . 1$$

where f(x, y) is a pixel value at coordinates (x, y) of an input image acquired from a camera.

Further, Eq. 1 may be modified according to an object to be recognized and the background. For example, in order to use, as a feature, an absolute variation in pixel values between two regions in a given mask, the Haar-like feature may be defined as an absolute value of a difference between the sum of pixel values belonging to region A and the sum of pixel values belonging to region B. In this case, the Haar-like feature is expressed by the following Eq. 2:

$${H}_{k} = \vert {\sum }_{( x , y ) ∈ A} f ( x , y ) - {\sum }_{( x , y ) ∈ B} f ( x , y ) \vert \qquad Eq . 2$$

Further, in order to be less sensitive to variation of surrounding pixel values, the Haar-like feature may be defined as a value normalized by standard deviation of pixel values in a region including all blocks of region A and region B. In this case, the Haar-like feature is expressed by the following Eq. 3:

$${H}_{k} = \frac{1}{{σ}_{AB}} ( {\sum }_{( x , y ) ∈ A} f ( x , y ) - {\sum }_{( x , y ) ∈ B} f ( x , y ) ) where {σ}_{AB} = \sqrt{\frac{1}{\vert A \vert + \vert B \vert} {\sum }_{( x , y ) ∈ A , B} {( f ( x , y ) - {μ}_{AB} )}^{2}} , \\ {μ}_{AB} = \frac{1}{\vert A \vert + \vert B \vert} {\sum }_{( x , y ) ∈ A , B} f ( x , y ) , \qquad Eq . 3$$

and |A| represents cardinality of region A, which means the number of pixels belonging to region A, i.e., an area of region A.

Further, the following Eq. 4 may be used by combining Eq. 2 and Eq. 3.

$${H}_{k} = \frac{1}{{σ}_{AB}} \vert {\sum }_{( x , y ) ∈ A} f ( x , y ) - {\sum }_{( x , y ) ∈ B} f ( x , y ) \vert \qquad Eq . 4$$

FIG. 2 illustrates an example in which the mask of FIG. 1 is applied to an input image. That is, FIG. 2 is an exemplary diagram in which the mask overlaps the input image in order to obtain the Haar-like feature in the input image, wherein an edge prototype is applied to FIG. 2A and a line prototype is applied to FIG. 2B.

In this case, since there is no information regarding the location and size of a target object to be recognized in the input image, the Haar-like feature should be calculated while moving the mask to a location where the target object is likely to exist, and also varying the size of the mask to correspond to the size of each object which is likely to exist. Accordingly, although the Haar-like feature is calculated as a simple sum, many iterations are needed, thereby requiring an efficient high-speed operation method. To this end, there has been proposed a method capable of rapidly calculating the sum of pixel values in a rectangular block while minimizing the number of iterations by using an integral image.

The integral image generates a summed area table (SAT) by calculating the sum of pixel values through one operation in order to accelerate the operation speed by minimizing redundant operations in image processing. The integral image I(x, y) for a specific input image f(x, y) is defined as cumulative pixel values from the origin of the input image to the coordinates (x, y) and is expressed by the following Eq. 5:

$$I ( x , y ) = {\sum }_{i = 0}^{x} {\sum }_{j = 0}^{y} f ( i , j ) \qquad Eq . 5$$

When Eq. 5 is calculated by a horizontal axis operation and a vertical axis operation, the integral image can be more efficiently obtained in terms of the operation speed. The result of Eq. 5 can be obtained by repeatedly using Eqs. 6 and 7.

i_{y}(x,y)=i_{y}(x,y−1)+f(x,y) Eq. 6

I(x,y)=I(x−1,y)+i_{y}(x,y) Eq. 7,

where

$${i}_{y} ( x , y - 1 ) = {\sum }_{j = 0}^{y - 1} f ( x , j )$$

is the sum of pixel values in a horizontal axis direction in the X^{th} column, supposing i_{y}(x,−1)=0, I(−1, y)=0

The sum of pixel values in a block having a certain size is simply obtained by the following Eq. 8 from the integral image.

$${\sum }_{i = {x}_{1}}^{{x}_{2}} {\sum }_{j = {y}_{1}}^{{y}_{2}} f ( i , j ) = I ( {x}_{2} , {y}_{2} ) + I ( {x}_{1} , {y}_{1} ) - ( I ( {x}_{1} , {y}_{2} ) + I ( {x}_{2} , {y}_{1} ) ) \qquad Eq . 8$$

FIG. 3 is an exemplary diagram showing a block having a certain size at a certain location of an input image. The sum of pixel values in a block of region D in gray in FIG. 3 may be calculated by subtracting a pixel value from the origin (0, 0) to the coordinates (x1, y2) and a pixel value from the origin (0, 0) to the coordinates (x2, y1) from a pixel value from the origin (0, 0) to the coordinates (x2, y2) and adding a pixel value from the origin (0, 0) to the coordinates (x1, y1) thereto.

That is, if the pixel value from the origin (0, 0) to the coordinates (x1, y1) is Ap, the pixel value from the origin (0, 0) to the coordinates (x1, y2) is Bp, the pixel value from the origin (0, 0) to the coordinates (x2, y1) is Cp, and the pixel value from the origin (0, 0) to the coordinates (x2, y2) is Dp, the pixel value of region D is obtained by Dp−(Bp+Cp)+Ap. Accordingly, the sum of pixel values in a certain block can be calculated by three operations (one addition and two subtractions in FIG. 3) from the integral image.

However, a conventional method for extracting a Haar-like feature does not sufficiently reflect statistical characteristic information of brightness values (pixel values) of an object to be detected (or recognized) because it uses, as a feature, only the sum of pixel values in a block.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a method for extracting a Haar-like feature based on moment capable of quickly detecting (or recognizing) an object in an input image by using a calculation of the n^{th} moment and the n^{th} central moment using a difference in statistical characteristics of pixel values in the input image.

The present invention also provides a method for creating the n^{th} integral image, and a method for calculating the n^{th} moment and a method for calculating the n^{th} central moment using the n^{th} integral image to process the iterations at a high speed using the n^{th} integral image.

The objects of the present invention are not limited thereto, and the other objects of the present invention will be described in or be apparent from the following description of the embodiments.

According to an aspect of the present invention, there is provided a method for extracting a Haar-like feature based on moment. More specifically, the method includes (a) applying a mask to an input image; (b) calculating the n^{th} moment of pixel values in each region to which the mask is applied; and (c) extracting a Haar-like feature based on a difference in the n^{th} moment between adjacent regions.

According to another aspect of the present invention, there is provided a method for extracting a Haar-like feature based on central moment, comprising the steps of: (a) applying a mask to an input image; (b) calculating the nth central moment of pixel values in each region to which the mask is applied; and (c) extracting a Haar-like feature based on a difference in the nth central moment between adjacent regions.

According to another aspect of the present invention, there is provided a method for creating the nth integral image, comprising the steps of: (a) selecting an origin of an input image and a location of a specific pixel; (b) raising to the nth power all pixel values from the origin of the input image to the location of the specific pixel; and (c) creating the nth integral image as a cumulative sum.

According to another aspect of the present invention, there is provided a method for creating the nth integral image at a high speed, comprising the steps of: (a) raising to the nth power a pixel value at current coordinates of an input image; (b) calculating a horizontal cumulative sum for the current coordinates by cumulating the nth power of the pixel value at the current coordinates in a horizontal direction; (c) creating the nth integral image as a cumulative sum in horizontal and vertical directions by cumulating the horizontal cumulative sum in a vertical direction; and (d) creating the nth integral image for all coordinates by repeatedly performing the steps (a), (b) and (c) while sequentially moving the current coordinates from the origin in the horizontal and vertical directions.

According to another aspect of the present invention, there is provided a method for calculating the nth moment using the nth integral image, comprising the steps of: (a) setting a block with four vertex coordinates in an input image; (b) creating the nth integral image for the four vertex coordinates; and (c) calculating the nth moment of the block based on a cumulative value of the four vertex coordinates of the nth integral image.

According to another aspect of the present invention, there is provided a A method for calculating the nth central moment using the nth integral image, comprising the steps of: (a) setting a block with four vertex coordinates in an input image; (b) creating the integral image for each order equal to or smaller than n; and (c) calculating the nth central moment of the block based on a cumulative value of the four vertex coordinates of the integral image for each order equal to or smaller than n.

The above and other features and advantages of the present invention will become more apparent by describing in detail exemplary embodiments thereof with reference to the attached drawings in which:

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates an exemplary diagram showing prototypes of masks used in extraction of a Haar-like feature;

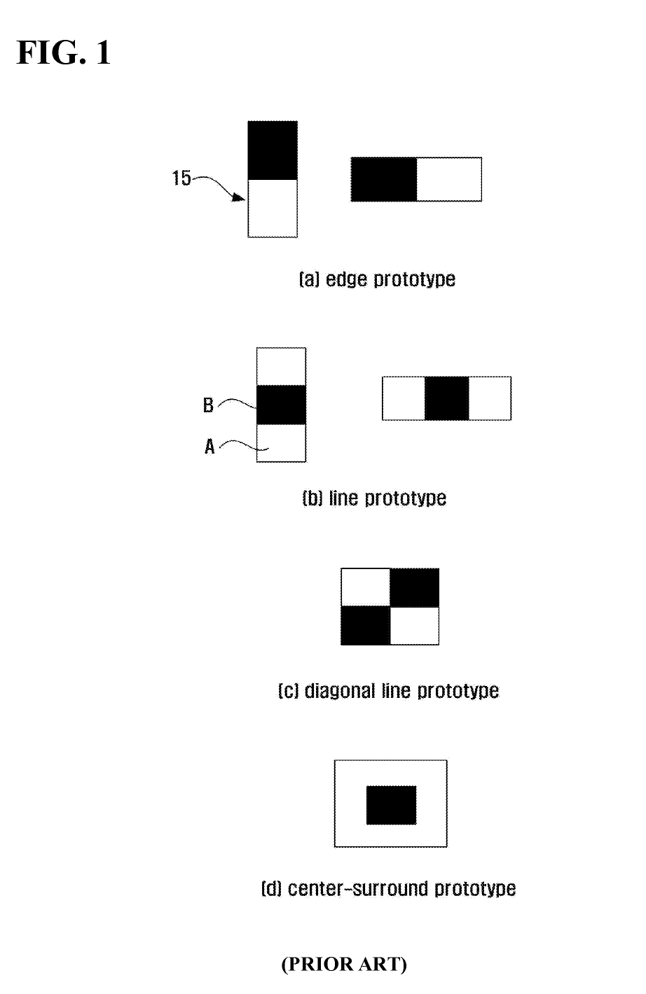

FIG. 2A-B illustrates an example in which the mask of FIG. 1 is applied to an input image;

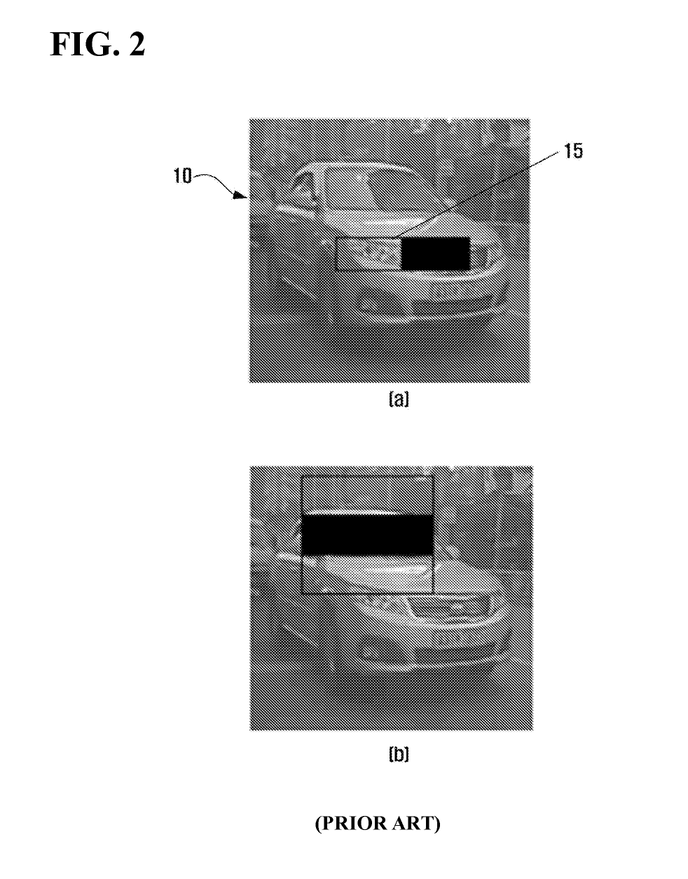

FIG. 3 is an exemplary diagram showing a block having a certain size at a certain location of an input image;

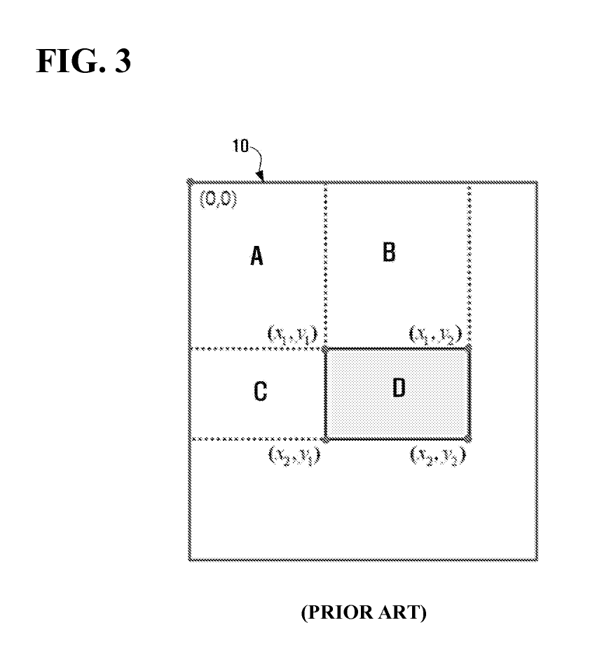

FIG. 4 is a flowchart showing a method for extracting a Haar-like feature based on moment in accordance with an exemplary embodiment of the present invention;

FIG. 5 is a flowchart showing a method for extracting a Haar-like feature based on moment in accordance with another exemplary embodiment of the present invention;

FIG. 6 is a flowchart showing a method for creating the n^{th} integral image in accordance with an exemplary embodiment of the present invention;

FIG. 7 is a flowchart showing a method for creating the n^{th} integral image at a high speed in accordance with another exemplary embodiment of the present invention;

FIG. 8 is a flowchart showing a method for calculating the n^{th} moment using the n^{th} integral image in accordance with the exemplary embodiment of the present invention; and

FIG. 9 is a flowchart showing a method for calculating the n^{th} central moment using the n^{th} integral image in accordance with the exemplary embodiment of the present invention.

### DETAILED DESCRIPTION OF THE DISCLOSURE

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the present invention will be described in detail with reference to the accompanying drawings.

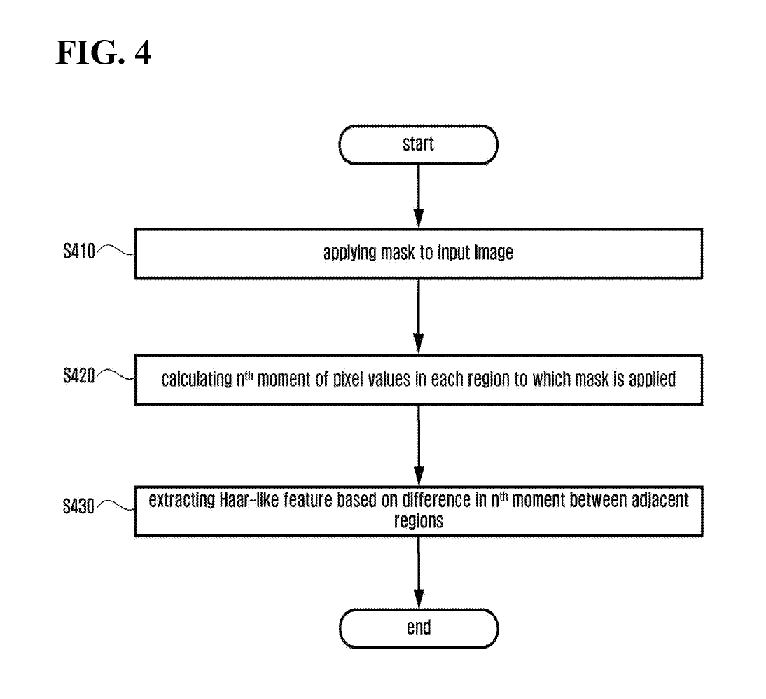

FIG. 4 is a flowchart showing a method for extracting a Haar-like feature based on moment in accordance with an embodiment of the present invention.

The method for extracting a Haar-like feature based on moment in accordance with the embodiment of the present invention includes applying a mask 15 to an input image 10 (S410), calculating the n^{th} moment of pixel values in each region to which the mask 15 is applied (S420), and extracting a Haar-like feature based on a difference in the n^{th} moment between adjacent regions (S430). In this case, generally, n represents a natural number, but it is not limited thereto.

In this case, the n^{th} moment-based Haar-like feature Hₖ⁽ⁿ⁾ using the k^{th} mask 15 is a difference (or a sum of products of weights) between the n^{th} moment of blocks of region A and the n^{th} moment of blocks of region B in the mask 15. In this case, in order to minimize an influence due to a block size and be less sensitive to variation of surrounding pixel values, the Haar-like feature is normalized by the n^{th} power of standard deviation of pixel values in a region including all blocks of region A and region B.

The moment-based Haar-like feature is extracted using at least one of the following equations.

$$\begin{matrix}{H}_{k}^{( n )} = \frac{1}{{σ}_{AB}^{n}} ( \frac{1}{\vert A \vert} {\sum }_{( x , y ) ∈ A} {( f ( x , y ) )}^{n} - \frac{1}{\vert B \vert} {\sum }_{( x , y ) ∈ B} {( f ( x , y ) )}^{n} ) & Eq . 9 \\ {H}_{k}^{( n )} = \frac{1}{{σ}_{AB}^{n}} \vert \frac{1}{\vert A \vert} {\sum }_{( x , y ) ∈ A} {( f ( x , y ) )}^{n} - \frac{1}{\vert B \vert} {\sum }_{( x , y ) ∈ B} {( f ( x , y ) )}^{n} \vert \\ where \\ {σ}_{AB} = \sqrt{\frac{1}{\vert A \vert + \vert B \vert} {\sum }_{( x , y ) ∈ A , B} {( f ( x , y ) - {μ}_{AB} )}^{2}} , \\ {μ}_{AB} = \frac{1}{\vert A \vert + \vert B \vert} {\sum }_{( x , y ) ∈ A , B} f ( x , y ) , & Eq . 10\end{matrix}$$

|A| and |B| represent cardinality of regions A and B, which means the number of pixels belonging to regions A and B, and f(x, y) is a pixel value at coordinates (x, y).

The Haar-like feature based on the n^{th} moment has different statistical characteristics according to the order n, and it is effective from a probabilistic point of view in detecting and recognizing an object to use an integer value ranging from 1 to 4 as a value of the order n. Accordingly, it is preferable that the order n is at least one of 1, 2, 3 and 4. The Haar-like feature based on the n^{th} moment (n=2, 3, 4) except for a case of n=1 is effective when the local average of pixel values is close to 0 over the whole image.

When the order n is 1, the Haar-like feature based on the 1^{st} moment is obtained as a difference in the average of pixel values between two or more adjacent blocks in the input image 10. The Haar-like feature based on the 1^{st} moment is defined as a difference (or a sum of products of weights) between an average of pixel values of blocks of group A and an average of pixel values of blocks of group B in the mask 15, which is normalized by the standard deviation of pixel values in a region of the mask 15 including group A and group B. The Haar-like feature based on the 1^{st} moment is expressed by the following Eq. 11 or 12:

$$\begin{matrix}{H}_{k}^{( 1 )} = \frac{1}{{σ}_{AB}} ( \frac{1}{\vert A \vert} {\sum }_{( x , y ) ∈ A} f ( x , y ) - \frac{1}{\vert B \vert} {\sum }_{( x , y ) ∈ B} f ( x , y ) ) , & Eq . 11 \\ {H}_{k}^{( 1 )} = \frac{1}{{σ}_{AB}} \vert \frac{1}{\vert A \vert} {\sum }_{( x , y ) ∈ A} f ( x , y ) - \frac{1}{\vert B \vert} {\sum }_{( x , y ) ∈ B} f ( x , y ) \vert , \\ where \\ {σ}_{AB} = \sqrt{\frac{1}{\vert A \vert + \vert B \vert} {\sum }_{( x , y ) ∈ A , B} {( f ( x , y ) - {μ}_{AB} )}^{2}} , and \\ {μ}_{AB} = \frac{1}{\vert A \vert + \vert B \vert} {\sum }_{( x , y ) ∈ A , B} f ( x , y ) . & Eq . 12\end{matrix}$$

When the order n is 2, the Haar-like feature based on the 2^{nd} moment is obtained as a difference in the 2^{nd} moment of pixel values between two or more adjacent blocks in the input image 10. The Haar-like feature based on the 2^{nd} moment is defined as a difference (or a sum of products of weights) between the 2^{nd} moment of pixel values of blocks of group A and the 2^{nd} moment of pixel values of blocks of group B in the mask 15, which is normalized by variance of pixel values in a region of the mask 15 including group A and group B. The Haar-like feature based on the 2^{nd} moment is expressed by the following Eq. 13 or 14:

$$\begin{matrix}{H}_{k}^{( 2 )} = \frac{1}{{σ}_{AB}^{2}} ( \frac{1}{\vert A \vert} {\sum }_{( x , y ) ∈ A} {( f ( x , y ) )}^{2} - \frac{1}{\vert B \vert} {\sum }_{( x , y ) ∈ B} {( f ( x , y ) )}^{2} ) , & Eq . 13 \\ {H}_{k}^{( 2 )} = \frac{1}{{σ}_{AB}^{2}} \vert \frac{1}{\vert A \vert} {\sum }_{( x , y ) ∈ A} {( f ( x , y ) )}^{2} - \frac{1}{\vert B \vert} {\sum }_{( x , y ) ∈ B} {( f ( x , y ) )}^{2} \vert , \\ where \\ {σ}_{AB} = \sqrt{\frac{1}{\vert A \vert + \vert B \vert} {\sum }_{( x , y ) ∈ A , B} {( f ( x , y ) - {μ}_{AB} )}^{2}} , and \\ {μ}_{AB} = \frac{1}{\vert A \vert + \vert B \vert} {\sum }_{( x , y ) ∈ A , B} f ( x , y ) . & Eq . 14\end{matrix}$$

When the order n is 3, the Haar-like feature based on the 3^{rd} moment is obtained as a difference in the 3^{rd} moment of pixel values between two or more adjacent blocks in the input image 10. The Haar-like feature based on the 3^{rd} moment is defined as a difference (or a sum of products of weights) between the 3^{rd} moment of pixel values of blocks of group A and the 3^{rd} moment of pixel values of blocks of group B in the mask 15, which is normalized by the 3^{rd} power of standard deviation of pixel values in a region of the mask 15 including group A and group B. The Haar-like feature based on the 3^{rd} moment is expressed by the following Eq. 15 or 16:

$$\begin{matrix}{H}_{k}^{( 3 )} = \frac{1}{{σ}_{AB}^{3}} ( \frac{1}{\vert A \vert} {\sum }_{( x , y ) ∈ A} {( f ( x , y ) )}^{3} - \frac{1}{\vert B \vert} {\sum }_{( x , y ) ∈ B} {( f ( x , y ) )}^{3} ) , & Eq . 15 \\ {H}_{k}^{( 3 )} = \frac{1}{{σ}_{AB}^{3}} \vert \frac{1}{\vert A \vert} {\sum }_{( x , y ) ∈ A} {( f ( x , y ) )}^{3} - \frac{1}{\vert B \vert} {\sum }_{( x , y ) ∈ B} {( f ( x , y ) )}^{3} \vert , \\ where \\ {σ}_{AB} = \sqrt{\frac{1}{\vert A \vert + \vert B \vert} {\sum }_{( x , y ) ∈ A , B} {( f ( x , y ) - {μ}_{AB} )}^{2}} , and \\ {μ}_{AB} = \frac{1}{\vert A \vert + \vert B \vert} {\sum }_{( x , y ) ∈ A , B} f ( x , y ) . & Eq . 16\end{matrix}$$

When the order n is 4, the Haar-like feature based on the 4^{th} moment is obtained as a difference in the 4^{th} moment of pixel values between two or more adjacent blocks in the input image 10. The Haar-like feature based on the 4^{th} moment is defined as a difference (or a sum of products of weights) between the 4^{th} moment of pixel values of blocks of group A and the 4^{th} moment of pixel values of blocks of group B in the mask 15, which is normalized by the 4^{th} power of standard deviation of pixel values in a region of the mask 15 including group A and group B. The Haar-like feature based on the 4^{th} moment is expressed by the following Eq. 17 or 18:

$$\begin{matrix}{H}_{k}^{( 4 )} = \frac{1}{{σ}_{AB}^{4}} ( \frac{1}{\vert A \vert} {\sum }_{( x , y ) ∈ A} {( f ( x , y ) )}^{4} - \frac{1}{\vert B \vert} {\sum }_{( x , y ) ∈ B} {( f ( x , y ) )}^{4} ) , & Eq . 17 \\ {H}_{k}^{( 4 )} = \frac{1}{{σ}_{AB}^{4}} \vert \frac{1}{\vert A \vert} {\sum }_{( x , y ) ∈ A} {( f ( x , y ) )}^{4} - \frac{1}{\vert B \vert} {\sum }_{( x , y ) ∈ B} {( f ( x , y ) )}^{4} \vert , \\ where \\ {σ}_{AB} = \sqrt{\frac{1}{\vert A \vert + \vert B \vert} {\sum }_{( x , y ) ∈ A , B} {( f ( x , y ) - {μ}_{AB} )}^{2}} , and \\ {μ}_{AB} = \frac{1}{\vert A \vert + \vert B \vert} {\sum }_{( x , y ) ∈ A , B} f ( x , y ) . & Eq . 18\end{matrix}$$

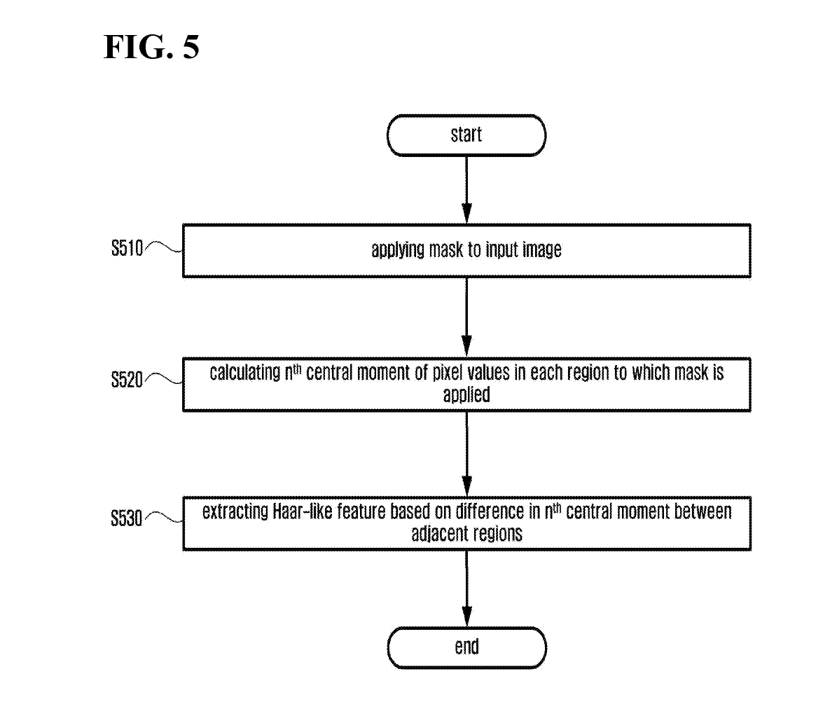

FIG. 5 is a flowchart showing a method for extracting a Haar-like feature based on moment in accordance with another embodiment of the present invention.

The method for extracting a Haar-like feature based on moment in accordance with another embodiment of the present invention includes applying the mask 15 to the input image 10 (S510), calculating the n^{th} central moment of pixel values in each region to which the mask 15 is applied (S520), and extracting a Haar-like feature based on a difference in the n^{th} central moment between adjacent regions (S530). In this case, generally, n represents a natural number, but it is not limited thereto. The Haar-like feature based on the n^{th} central moment is obtained as a difference in the n^{th} central moment of pixel values between two or more adjacent blocks in the input image 10.

The Haar-like feature H_Cₖ⁽ⁿ⁾ based on the n^{th} central moment is defined as a difference (or a sum of products of weights) between the n^{th} central moment of blocks of region A and the n^{th} central moment of blocks of group B in the k^{th} mask 15, which is normalized by the n^{th} power of standard deviation of pixel values in a region of the mask 15 including group A and group B.

The Haar-like feature is extracted using at least one of the following equations.

$$\begin{matrix}{H\_C}_{k}^{( n )} = \frac{1}{{σ}_{AB}^{n}} ( \frac{1}{\vert A \vert} {\sum }_{( x , y ) ∈ A} {( f ( x , y ) - {μ}_{A} )}^{n} - \frac{1}{\vert B \vert} {\sum }_{( x , y ) ∈ B} {( f ( x , y ) - {μ}_{B} )}^{n} ) & Eq . 19 \\ {H\_C}_{k}^{( n )} = \frac{1}{{σ}_{AB}^{n}} \vert \frac{1}{\vert A \vert} {\sum }_{( x , y ) ∈ A} {( f ( x , y ) - {μ}_{A} )}^{n} - \frac{1}{\vert B \vert} {\sum }_{( x , y ) ∈ B} {( f ( x , y ) - {μ}_{B} )}^{n} \vert \\ where \\ {σ}_{AB} = \sqrt{\frac{1}{\vert A \vert + \vert B \vert} {\sum }_{( x , y ) ∈ A , B} {( f ( x , y ) - {μ}_{AB} )}^{2}} , \\ {μ}_{AB} = \frac{1}{\vert A \vert + \vert B \vert} {\sum }_{( x , y ) ∈ A , B} f ( x , y ) , {μ}_{A} = \frac{1}{\vert A \vert} {\sum }_{( x , y ) ∈ A} f ( x , y ) , \\ {μ}_{B} = \frac{1}{\vert B \vert} {\sum }_{( x , y ) ∈ B} f ( x , y ) , & Eq . 20\end{matrix}$$

H_Cₖ⁽ⁿ⁾ is Haar-like feature information of the k^{th} mask, |A| and |B| represent the number of pixels belonging to regions A and B, and f(x, y) is a pixel value at coordinates (x, y).

The Haar-like feature based on the n^{th} central moment has different statistical characteristics according to the order n, and it is effective from a probabilistic point of view in detecting and recognizing an object to use an integer value ranging from 2 to 4 as a value of the order n. Accordingly, it is preferable that the order n is at least one of 2, 3 and 4.

When the order n is 2, the Haar-like feature based on the 2^{nd} central moment (variance) is obtained as a difference in the 2^{nd} central moment (variance) of pixel values between two or more adjacent blocks in the input image 10. The Haar-like feature based on the 2^{nd} central moment (variance) is defined as a difference (or a sum of products of weights) between the 2^{nd} central moment (variance) of pixel values of blocks of group A and the 2^{nd} central moment (variance) of pixel values of blocks of group B in the mask 15, which is normalized by variance of pixel values in a region of the mask 15 including group A and group B. The Haar-like feature based on the 2^{nd} central moment is expressed by the following Eq. 21 or 22:

$$\begin{matrix}{H\_C}_{k}^{( 2 )} = \frac{1}{{σ}_{AB}^{2}} ( \frac{1}{\vert A \vert} {\sum }_{( x , y ) ∈ A} {( f ( x , y ) - {μ}_{A} )}^{2} - \frac{1}{\vert B \vert} {\sum }_{( x , y ) ∈ B} {( f ( x , y ) - {μ}_{B} )}^{2} ) & Eq . 21 \\ {H\_C}_{k}^{( 2 )} = \frac{1}{{σ}_{AB}^{2}} \vert \frac{1}{\vert A \vert} {\sum }_{( x , y ) ∈ A} {( f ( x , y ) - {μ}_{A} )}^{2} - \frac{1}{\vert B \vert} {\sum }_{( x , y ) ∈ B} {( f ( x , y ) - {μ}_{B} )}^{2} \vert \\ where \\ {σ}_{AB} = \sqrt{\frac{1}{\vert A \vert + \vert B \vert} {\sum }_{( x , y ) ∈ A , B} {( f ( x , y ) - {μ}_{AB} )}^{2}} , \\ {μ}_{AB} = \frac{1}{\vert A \vert + \vert B \vert} {\sum }_{( x , y ) ∈ A , B} f ( x , y ) , {μ}_{A} = \frac{1}{\vert A \vert} {\sum }_{( x , y ) ∈ A} f ( x , y ) , and \\ {μ}_{B} = \frac{1}{\vert B \vert} {\sum }_{( x , y ) ∈ B} f ( x , y ) . & Eq . 22\end{matrix}$$

When the order n is 3, the Haar-like feature based on the 3^{rd} central moment (skewness) is obtained as a difference in the 3^{rd} central moment (skewness) of pixel values between two or more adjacent blocks in the input image 10. The Haar-like feature based on the 3^{rd} central moment (skewness) is defined as a difference (or a sum of products of weights) between the 3^{rd} central moment (skewness) of pixel values of blocks of group A and the 3^{rd} central moment (skewness) of pixel values of blocks of group B in the mask 15, which is normalized by the 3^{rd} power of standard deviation of pixel values in a region of the mask 15 including group A and group B. The Haar-like feature based on the 3^{rd} moment is expressed by the following Eq. 23 or 24:

$$\begin{matrix}{H\_C}_{k}^{( 3 )} = \frac{1}{{σ}_{AB}^{3}} ( \frac{1}{\vert A \vert} {\sum }_{( x , y ) ∈ A} {( f ( x , y ) - {μ}_{A} )}^{3} - \frac{1}{\vert B \vert} {\sum }_{( x , y ) ∈ B} {( f ( x , y ) - {μ}_{B} )}^{3} ) , & Eq . 23 \\ {H\_C}_{k}^{( 3 )} = \frac{1}{{σ}_{AB}^{3}} \vert \frac{1}{\vert A \vert} {\sum }_{( x , y ) ∈ A} {( f ( x , y ) - {μ}_{A} )}^{3} - \frac{1}{\vert B \vert} {\sum }_{( x , y ) ∈ B} {( f ( x , y ) - {μ}_{B} )}^{3} \vert , \\ where \\ {σ}_{AB} = \sqrt{\frac{1}{\vert A \vert + \vert B \vert} {\sum }_{( x , y ) ∈ A , B} {( f ( x , y ) - {μ}_{AB} )}^{2}} , \\ {μ}_{AB} = \frac{1}{\vert A \vert + \vert B \vert} {\sum }_{( x , y ) ∈ A , B} f ( x , y ) , {μ}_{A} = \frac{1}{\vert A \vert} {\sum }_{( x , y ) ∈ A} f ( x , y ) , and \\ {μ}_{B} = \frac{1}{\vert B \vert} {\sum }_{( x , y ) ∈ B} f ( x , y ) . & Eq . 24\end{matrix}$$

When the order n is 4, the Haar-like feature based on the 4^{th} central moment (kurtosis) is obtained as a difference in the 4^{th} central moment (kurtosis) of pixel values between two or more adjacent blocks in the input image 10. The Haar-like feature based on the 4^{th} central moment (kurtosis) is defined as a difference (or a sum of products of weights) between the 4^{th} central moment (kurtosis) of pixel values of blocks of group A and the 4^{th} central moment (kurtosis) of pixel values of blocks of group B in the mask 15, which is normalized by the 4^{th} power of standard deviation of pixel values in a region of the mask 15 including group A and group B. The Haar-like feature based on the 4^{th} central moment (kurtosis) is expressed by the following Eq. 25 or 26:

$$\begin{matrix}{H\_C}_{k}^{( 4 )} = \frac{1}{{σ}_{AB}^{4}} ( \frac{1}{\vert A \vert} {\sum }_{( x , y ) ∈ A} {( f ( x , y ) - {μ}_{A} )}^{4} - \frac{1}{\vert B \vert} {\sum }_{( x , y ) ∈ B} {( f ( x , y ) - {μ}_{B} )}^{4} ) & Eq . 25 \\ {H\_C}_{k}^{( 4 )} = \frac{1}{{σ}_{AB}^{4}} \vert \frac{1}{\vert A \vert} {\sum }_{( x , y ) ∈ A} {( f ( x , y ) - {μ}_{A} )}^{4} - \frac{1}{\vert B \vert} {\sum }_{( x , y ) ∈ B} {( f ( x , y ) - {μ}_{B} )}^{4} \vert \\ where \\ {σ}_{AB} = \sqrt{\frac{1}{\vert A \vert + \vert B \vert} {\sum }_{( x , y ) ∈ A , B} {( f ( x , y ) - {μ}_{AB} )}^{2}} , \\ {μ}_{AB} = \frac{1}{\vert A \vert + \vert B \vert} {\sum }_{( x , y ) ∈ A , B} f ( x , y ) , {μ}_{A} = \frac{1}{\vert A \vert} {\sum }_{( x , y ) ∈ A} f ( x , y ) , and \\ {μ}_{B} = \frac{1}{\vert B \vert} {\sum }_{( x , y ) ∈ B} f ( x , y ) . & Eq . 26\end{matrix}$$

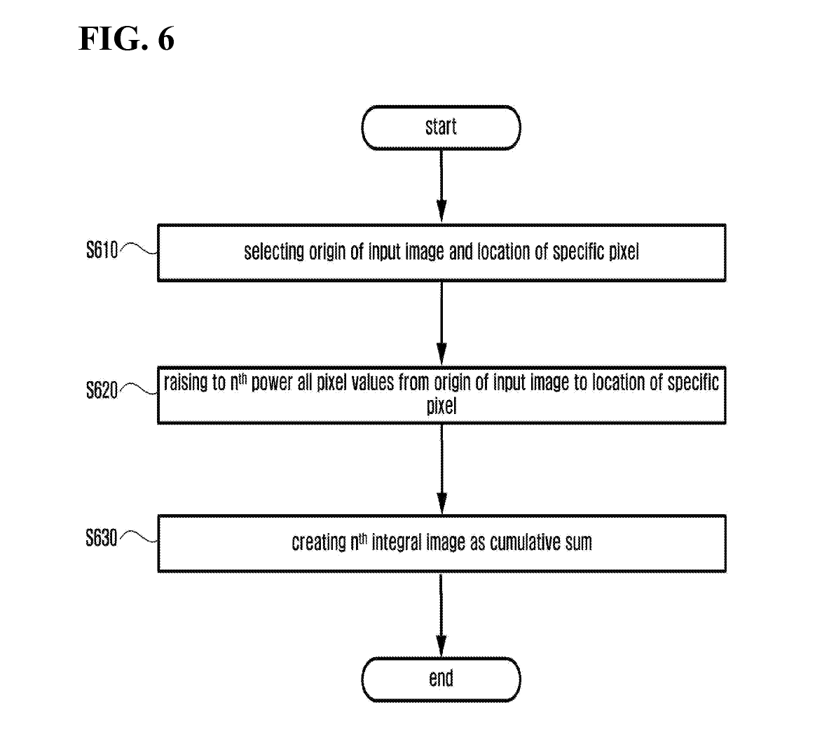

FIG. 6 is a flowchart showing a method for creating the n^{th} integral image in accordance with an embodiment of the present invention.

The method for creating the n^{th} integral image in accordance with the embodiment of the present invention includes selecting the origin of the input image 10 and a location of a specific pixel (S610), raising to the n^{th} power all pixel values from the origin of the input image 10 to the location of the specific pixel (S620), and creating the n^{th} integral image as a cumulative sum (S630).

The n^{th} integral image I⁽ⁿ⁾(x, y) for a specific pixel f(x, y) of a given input image 10 is defined as a cumulative sum obtained by raising to the n^{th} power all pixel values from the origin (0, 0) of the input image 10 to the specific coordinates (x, y), and is expressed by the following Eq. 27:

$${I}^{( n )} ( x , y ) ≡ {\sum }_{i = 0}^{x} {\sum }_{j = 0}^{y} {( f ( i , j ) )}^{n} , \qquad Eq . 27$$

where I⁽ⁿ⁾(x, y) is the n^{th} integral image, and f(i, j) is a pixel value of coordinates (i, j).

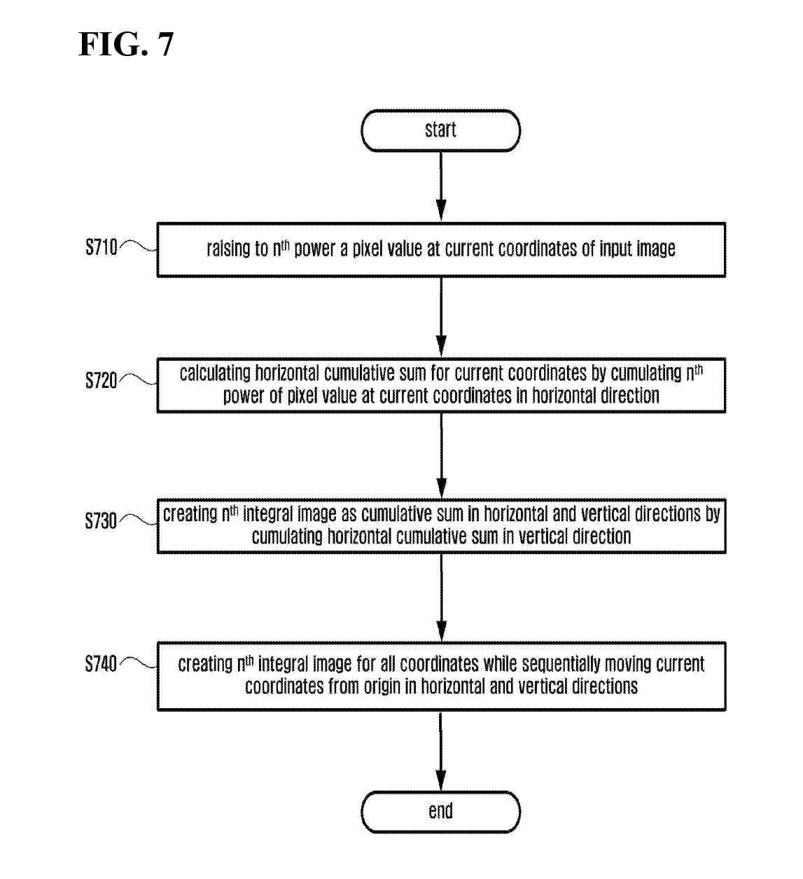

FIG. 7 is a flowchart showing a method for creating the n^{th} integral image at a high speed in accordance with another embodiment of the present invention.

The method for creating the n^{th} integral image in accordance with another embodiment of the present invention includes raising to the n^{th} power a pixel value at the current coordinates of the input image 10 (S710), calculating a horizontal cumulative sum for the current coordinates by cumulating the n^{th} power of the pixel value at the current coordinates in the horizontal direction (S720), and creating the n^{th} integral image as a cumulative sum in horizontal and vertical directions by cumulating the horizontal cumulative sum in a vertical direction (S730). Further, the n^{th} integral image for all coordinates is created by repeating the steps S710, S720 and S730 for all coordinates while sequentially moving the current coordinates from the origin in the horizontal and vertical directions (S740).

That is, when horizontal calculation and vertical calculation are separately performed to create the n^{th} integral image, it is possible to create the n^{th} integral image at a higher speed without using an additional memory.

Accordingly, the n^{th} integral image can be calculated by applying the following Eq. 28 in the step S720, and applying the following Eq. 29 in the step S730.

i_{y}⁽ⁿ⁾(x,y)=i_{y}⁽ⁿ⁾(x,y−1)+(f(x,y))ⁿ Eq. 28,

I₍ₙ₎(x,y)=I⁽ⁿ⁾(x−1,y)+i_{y}⁽ⁿ⁾(x,y) Eq. 29,

where I⁽ⁿ⁾(x,y) is the n^{th} integral image, f(x, y) is a pixel value at coordinates (x, y),

$${i}_{y}^{( n )} ( x , y - 1 ) = {\sum }_{j = 0}^{y - 1} {( f ( x , j ) )}^{n}$$

is a sum of pixel values in a horizontal direction in
the x^{th} column, and i_{y}⁽ⁿ⁾(x,−1)=0, I⁽ⁿ⁾(−1,y)=0.

In case of calculating the n^{th} moment of the pixel values in rectangular blocks having various sizes by moving the block to all pixel locations in the image data, many repeated calculations are performed. Also in the method for extracting a Haar-like feature based on moment described with reference to FIGS. 4 and 5, many repeated calculations are performed. This is because there is no information on the size and location of a target object to be detected in the input image 10, it is required to move the block and vary the size of the block to meet all locations where the target object is likely to exist and all sizes of objects which are likely to exist.

Accordingly, it is possible to quickly calculate the moment of the pixel values in the rectangular blocks by reducing the number of the repeated calculations of the method for extracting a Haar-like feature based on moment described with reference to FIGS. 6 and 7.

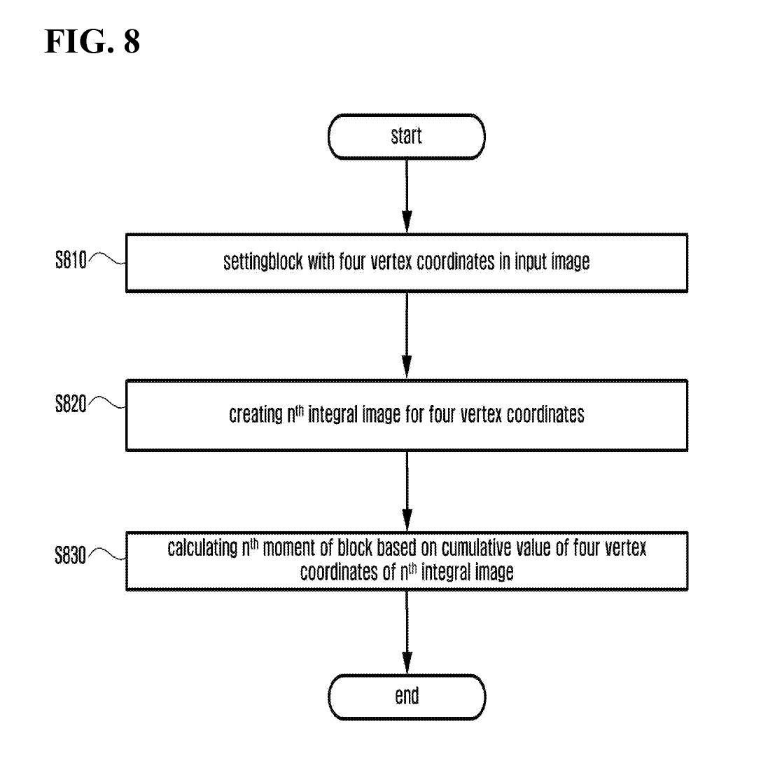

FIG. 8 is a flowchart showing a method for calculating the n^{th} moment using the n^{th} integral image in accordance with the embodiment of the present invention.

The method for calculating the n^{th} moment using the n^{th} integral image in accordance with the embodiment of the present invention includes setting a block with four vertex coordinates in the input image 10 (S810), creating the n^{th} integral image for the four vertex coordinates (S820), and calculating the n^{th} moment of the block based on a cumulative value of the four vertex coordinates of the created n^{th} integral image (S830).

In this case, generally, n represents a natural number, but it is not limited thereto. Further, it is effective from a probabilistic point of view in detecting and recognizing an object to use an integer value ranging from 1 to 4 as a value of the order n. Accordingly, it is preferable that the order n is at least one of 1, 2, 3 and 4.

For example, the n^{th} moment of pixel values in a rectangular block having vertices of coordinates (x₁, y₁), (x₁, y₂), (x₂, y₁), (x₂, y₂) is expressed by the following Eq. 30:

$${m}_{Δ}^{( n )} = \frac{1}{( {x}_{2} - {x}_{1} ) ( {y}_{2} - {y}_{1} )} {\sum }_{i = {x}_{1}}^{{x}_{2}} {\sum }_{j = {y}_{1}}^{{y}_{2}} {( f ( i , j ) )}^{n} = \frac{1}{( {x}_{2} - {x}_{1} ) ( {y}_{2} - {y}_{1} )} ( {I}^{( n )} ( {x}_{2} , {y}_{2} ) + {I}^{( n )} ( {x}_{1} , {y}_{1} ) - ( {I}^{( n )} ( {x}_{2} , {y}_{1} ) + {I}^{( n )} ( {x}_{1} , {y}_{2} ) ) ) \qquad Eq . 30$$

where m_{Δ}⁽ⁿ⁾ is the n^{th} moment, and I⁽ⁿ⁾(x,y) is the n^{th} integral image of a pixel f(x, y).

In case of using the previously calculated n^{th} integral image, regardless of the size of the rectangular block, it is possible to calculate the n^{th} moment through three additions and subtractions and one division except for the repeatedly used operation of (x₂−x₁)(y₂−y₁) corresponding to the size of the block.

When the order n is 1, the 1^{st} moment of pixel values in a rectangular block having vertices of coordinates (x₁, y₁), (x₁, x²), (x₂, y₁), (x₂, y₂) is expressed by the following Eq. 31:

$${m}_{Δ}^{( 1 )} = \frac{1}{( {x}_{2} - {x}_{1} ) ( {y}_{2} - {y}_{1} )} ( {I}^{( 1 )} ( {x}_{2} , {y}_{2} ) + {I}^{( 1 )} ( {x}_{1} , {y}_{1} ) - ( {I}^{( 1 )} ( {x}_{2} , {y}_{1} ) + {I}^{( 1 )} ( {x}_{1} , {y}_{2} ) ) ) ≡ {μ}_{Δ} \qquad Eq . 31$$

In this case, m_{Δ}⁽¹⁾ is the 1^{st} moment obtained by using the 1^{st} integral image I⁽¹⁾(x,y). In case of using the previously calculated 1^{st} integral image, regardless of the size of the rectangular block, it is possible to calculate the 1^{st} moment through three additions and subtractions and one division except for the repeatedly used operation of (x₂, x₁)(y₂−y₁) corresponding to the size of the block.

When the order n is 2, the 2^{nd} moment of pixel values in a rectangular block having vertices of coordinates (x₁, y₁), (x₁, y₂), (x₂, y₁), (x₂, y₂) is expressed by the following Eq. 32:

$${m}_{Δ}^{( 2 )} = \frac{1}{( {x}_{2} - {x}_{1} ) ( {y}_{2} - {y}_{1} )} ( {I}^{( 2 )} ( {x}_{2} , {y}_{2} ) + {I}^{( 2 )} ( {x}_{1} , {y}_{1} ) - ( {I}^{( 2 )} ( {x}_{2} , {y}_{1} ) + {I}^{( 2 )} ( {x}_{1} , {y}_{2} ) ) ) \qquad Eq . 32$$

In this case, m_{Δ}⁽²⁾ is the 2^{nd} moment obtained by using the 2^{nd} integral image I⁽²⁾(x,y). In case of using the previously calculated 2^{nd} integral image, regardless of the size of the rectangular block, it is possible to calculate the 2^{nd} moment with three additions and subtractions and one division except for the repeatedly used operation of (x₂−x₁)(y₂−y₁) corresponding to the size of the block.

When the order n is 3, the 3^{rd} moment of pixel values in a rectangular block having vertices of coordinates (x₁, y₁), (x₁, y₂), (x₂, y₁), (x₂, y₂) is expressed by the following Eq. 33:

$${m}_{Δ}^{( 3 )} = \frac{1}{( {x}_{2} - {x}_{1} ) ( {y}_{2} - {y}_{1} )} ( {I}^{( 3 )} ( {x}_{2} , {y}_{2} ) + {I}^{( 3 )} ( {x}_{1} , {y}_{1} ) - ( {I}^{( 3 )} ( {x}_{2} , {y}_{1} ) + {I}^{( 3 )} ( {x}_{1} , {y}_{2} ) ) ) \qquad Eq . 33$$

In this case, m_{Δ}⁽³⁾ is the 3^{rd} moment obtained by using the 3^{rd} integral image I⁽³⁾(x,y). In case of using the previously calculated 3^{rd} integral image, regardless of the size of the rectangular block, it is possible to calculate the 3^{rd} moment through three additions and subtractions and one division except for the repeatedly used operation of (X₂−x₁)(y₂−y₁) corresponding to the size of the block.

When the order n is 4, the 4^{th} moment of pixel values in a rectangular block having vertices of coordinates (x₁, y₁), (x₁, y₂), (x₂, y₁), (x₂, y₂) is expressed by the following Eq. 34:

$${m}_{Δ}^{( 4 )} = \frac{1}{( {x}_{2} - {x}_{1} ) ( {y}_{2} - {y}_{1} )} ( {I}^{( 4 )} ( {x}_{2} , {y}_{2} ) + {I}^{( 4 )} ( {x}_{1} , {y}_{1} ) - ( {I}^{( 4 )} ( {x}_{2} , {y}_{1} ) + {I}^{( 4 )} ( {x}_{1} , {y}_{2} ) ) ) \qquad Eq . 34$$

In this case, m_{Δ}⁽⁴⁾ is the 4^{th} moment obtained by using the 4^{th} integral image I⁽⁴⁾(x, y). In case of using the previously calculated 4^{th} integral image, regardless of the size of the rectangular block, it is possible to calculate the 4^{th} moment through three additions and subtractions and one division except for the repeatedly used operation of (x₂−x₁)(y₂−y₁) corresponding to the size of the block.

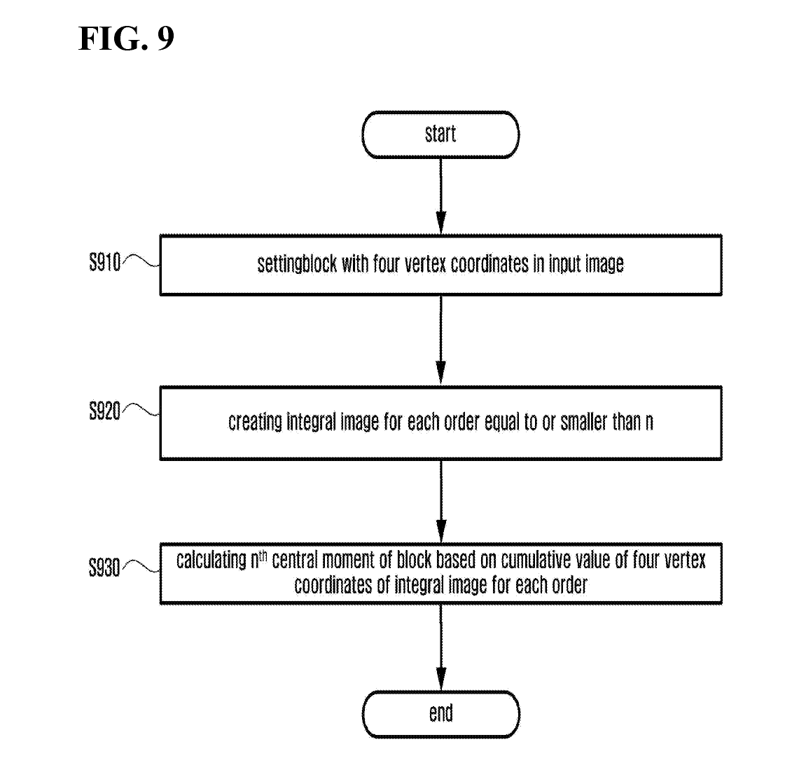

FIG. 9 is a flowchart showing a method for calculating the n^{th} central moment using the n^{th} integral image in accordance with the embodiment of the present invention.

The method for calculating the n^{th} central moment using the n^{th} integral image in accordance with the embodiment of the present invention includes setting a block with four vertex coordinates in the input image 10 (S910), creating the integral image for each order equal to or smaller than n (S920), and calculating the n^{th} central moment of the block based on a cumulative value of the four vertex coordinates of the created integral image for each order equal to or smaller than n (S930).

For example, creating the integral image for each order means obtaining the 1^{st} integral image and the 2^{nd} integral image if n is 2, and obtaining the 1^{st} to 4^{th} integral images if n is 4.

The Haar-like feature based on the n^{th} central moment has different statistical characteristics according to the order n, and it is effective from a probabilistic point of view in detecting and recognizing an object to use an integer value ranging from 2 to 4 as a value of the order n. Accordingly, it is preferable that the order n is at least one of 2, 3 and 4 among natural numbers.

The general equation of the n^{th} central moment of pixel values in a certain rectangular block having vertices of four pairs of coordinates (x₁, y₁), (x₁, y₂), (x₂, y₁), (x₂, y₂) in a given image may be defined by the following Eq. 35:

$${m\_c}_{Δ}^{( n )} = \frac{1}{( {x}_{2} - {x}_{1} ) ( {y}_{2} - {y}_{1} )} {\sum }_{i = {x}_{1}}^{{x}_{2}} {\sum }_{j = {y}_{1}}^{{y}_{2}} {( f ( i , j ) - {μ}_{Δ} )}^{n} \qquad Eq . 35$$

where μΔ is an average of pixel values in a block, and

$${μ}_{Δ} = \frac{1}{( {x}_{2} - {x}_{1} ) ( {y}_{2} - {y}_{1} )} {\sum }_{i = {x}_{1}}^{{x}_{2}} {\sum }_{j = {y}_{1}}^{{y}_{2}} f ( i , j ) .$$

By using the integral image for each order equal to or smaller than n of the given image data, it is possible to achieve high-speed calculation of the central moment capable of effectively reducing the repeated calculations.

When the order n is 2, the 2^{nd} central moment (variance) m_c_{Δ}⁽²⁾ is calculated at a high speed using the 1^{st} integral image I⁽¹⁾(x, y) and the 2^{nd} integral image by the following Eq. 36:

m_{—}c_{Δ}⁽²⁾=m_{Δ}⁽²⁾−(m_{Δ}⁽¹⁾)²≡σ_{Δ}² Eq. 36

where m_{Δ}⁽¹⁾ and m_{Δ}⁽²⁾ are obtained by Eqs. 31 and 32 respectively.

In case of using the previously calculated 1^{st} integral image and 2^{nd} integral image, regardless of the size of the rectangular block, it is possible to calculate the 2^{nd} central moment through seven additions (or subtractions) and two multiplications (or divisions) except for the repeatedly used operation of (x₂−x₁)(y₂−y₁) corresponding to the size of the block.

When the order n is 3, the 3^{rd} central moment (skewness) m_c_{Δ}⁽³⁾ is calculated at a high speed using the 1^{st} integral image I⁽¹⁾(x, y), the 2^{nd} integral image I⁽²⁾(x, y) and the 3^{rd} integral image I⁽³⁾(x, y) a by the following Eq. 37:

m_{—}c_{Δ}⁽³⁾=m_{Δ}⁽³⁾−3m_{Δ}⁽¹⁾m_{Δ}⁽²⁾+2(m_{Δ}⁽¹⁾)³ Eq. 37

where m_{Δ}⁽¹⁾, m_{Δ}⁽²⁾, m_{Δ}⁽³⁾ are obtained by Eqs. 31, 32 and 33 respectively.

In case of using the previously calculated 1^{st} integral image, 2^{nd} integral image and 3^{rd} integral image, regardless of the size of the rectangular block, it is possible to calculate the 3^{rd} central moment through eleven additions (or subtractions), six multiplications (or divisions) and one operation of the 3^{rd} power except for the repeatedly used operation of (x₂−x₁)(y₂−y₁) corresponding to the size of the block.

When the order n is 4, the 4^{th} central moment (kurtosis) m_c_{Δ}⁽⁴⁾ is calculated at a high speed using the 1^{st} integral image I⁽¹⁾(x, y), the 2^{nd} integral image I⁽²⁾(x, y), the 3^{rd} integral image I⁽³⁾(x, y) and the 4^{th} integral image I⁽⁴⁾(x, y) by the following Eq. 38:

m_{—}c_{Δ}⁽⁴⁾=m_{Δ}⁽⁴⁾−4m_{Δ}⁽³⁾m_{Δ}⁽¹⁾+6m_{Δ}⁽²⁾(m_{Δ}⁽¹⁾)²−3(m_{Δ}⁽¹⁾)⁴ Eq. 38

where m_{Δ}⁽¹⁾, m_{Δ}⁽²⁾, m_{Δ}⁽³⁾, m_{Δ}⁽⁴⁾ are obtained by Eqs. 31, 32, 33 and 34 respectively.

In case of using the previously calculated 1^{st} integral image, 2^{nd} integral image, 3^{rd} integral image and 4^{th} integral image, regardless of the size of the rectangular block, it is possible to calculate the 4^{th} central moment through fifteen additions (or subtractions), nine multiplications (or divisions), one operation of the 2^{nd} power and one operation of the 3^{rd} power except for the repeatedly used operation of (x₂−x₁)(y₂−y₁) corresponding to the size of the block

Meanwhile, the method for extracting a Haar-like feature based on moment, the method for creating the n^{th} integral image, the method for calculating the n^{th} moment using the n^{th} integral image, and the method for calculating the n^{th} central moment using the n^{th} integral image in accordance with the present invention may be implemented as one module by software and hardware. The above-described embodiments of the present invention may be written as a program executable on a computer, and may be implemented on a general purpose computer to operate the program by using a non-transitory computer-readable storage medium. The computer-readable storage medium is implemented in the form of a magnetic medium such as a ROM, floppy disk, and hard disk, an optical medium such as CD and DVD and a carrier wave such as transmission through the Internet or over a Controller Area Network (CAN). Further, the computer-readable storage medium may be distributed to a computer system connected to the network such that a computer-readable code is stored and executed in the distribution manner.

According to the present invention, it is possible to quickly and accurately detect (or recognize) an object in an input image by using a method for extracting a Haar-like feature based on moment using a difference in statistical characteristics of pixel values in the input image.

Further, when calculating the moment using the n^{th} integral image, it is possible to rapidly calculate the n^{th} moment of the pixel values in a block by efficiently processing iterations.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method for detecting and recognizing objects of an image using Haar-like features, the method comprising:
extracting, by a processor, the Haar-like features from an input image using Haar-like feature extraction algorithm, and detecting and recognizing objects of the input image based on the extracted Haar-like features,
the Haar-like feature extraction algorithm:
(a) applying, by the processor, a mask to an input image; and
(b) calculating, by the processor, the n^{th} moment of pixel values in each region to which the mask is applied and extracting a Haar-like feature based on a difference in the n^{th} moment between adjacent regions.

2. The method of claim 1, wherein n is at least one of 1, 2, 3 and 4.

3. The method of claim 1, wherein the step (b) further comprises extracting the Haar-like feature based on at least one of the following equations:
$${H}_{k}^{( n )} = \frac{1}{{σ}_{AB}^{n}} ( \frac{1}{\vert A \vert} {\sum }_{( x , y ) ∈ A} {( f ( x , y ) )}^{n} - \frac{1}{\vert B \vert} {\sum }_{( x , y ) ∈ B} {( f ( x , y ) )}^{n} )$$
$$and$$
$${H}_{k}^{( n )} = \frac{1}{{σ}_{AB}^{n}} \vert \frac{1}{\vert A \vert} {\sum }_{( x , y ) ∈ A} {( f ( x , y ) )}^{n} - \frac{1}{\vert B \vert} {\sum }_{( x , y ) ∈ B} {( f ( x , y ) )}^{n} \vert , \\ where {σ}_{AB} = \sqrt{\frac{1}{\vert A \vert + \vert B \vert} {\sum }_{( x , y ) ∈ A , B} {( f ( x , y ) - {μ}_{AB} )}^{2}} , \\ {μ}_{AB} = \frac{1}{\vert A \vert + \vert B \vert} {\sum }_{( x , y ) ∈ A , B} f ( x , y ) ,$$

|A| and |B| respectively represent the number of pixels belonging to regions A and B, and f(x, y) is a pixel value at coordinates (x, y).

4. A method for detecting and recognizing objects of an image using Haar-like features, the method comprising:
extracting, by a processor, the Haar-like features from an input image using Haar-like feature extraction algorithm, and detecting and recognizing objects of the input image based on the extracted Haar-like features,
the Haar-like feature extraction algorithm:
(a) applying, by the processor, a mask to an input image; and
(b) calculating, by the processor, the n^{th} central moment of pixel values in each region to which the mask is applied and extracting a Haar-like feature based on a difference in the n^{th} central moment between adjacent regions.

5. The method of claim 4, wherein n is at least one of 1, 2, 3 and 4.

6. The method of claim 4, wherein the step (b) further comprises extracting the Haar-like feature based on at least one of the following equations:
$${H\_C}_{k}^{( n )} = \frac{1}{{σ}_{AB}^{n}} ( \frac{1}{\vert A \vert} {\sum }_{( x , y ) ∈ A} {( f ( x , y ) - {μ}_{A} )}^{n} - \frac{1}{\vert B \vert} {\sum }_{( x , y ) ∈ B} {( f ( x , y ) - {μ}_{B} )}^{n} )$$
$$and$$
$${H\_C}_{k}^{( n )} = \frac{1}{{σ}_{AB}^{n}} \vert \frac{1}{\vert A \vert} {\sum }_{( x , y ) ∈ A} {( f ( x , y ) - {μ}_{A} )}^{n} - \frac{1}{\vert B \vert} {\sum }_{( x , y ) ∈ B} {( f ( x , y ) - {μ}_{B} )}^{n} \vert$$
$$where {σ}_{AB} = \sqrt{\frac{1}{\vert A \vert + \vert B \vert} {\sum }_{( x , y ) ∈ A , B} {( f ( x , y ) - {μ}_{AB} )}^{2}} , \\ {μ}_{AB} = \frac{1}{\vert A \vert + \vert B \vert} {\sum }_{( x , y ) ∈ A , B} f ( x , y ) , \\ {μ}_{A} = \frac{1}{\vert A \vert} {\sum }_{( x , y ) ∈ A} f ( x , y ) , \\ {μ}_{B} = \frac{1}{\vert B \vert} {\sum }_{( x , y ) ∈ B} f ( x , y ) ,$$
H_Cₖ⁽ⁿ⁾ is Haar-like feature information of the k^{th} mask, |A| and |B| respectively represent the number of pixels belonging to regions A and B, and f(x, y) is a pixel value at coordinates (x, y).

7. A method for detecting and recognizing objects of an image using Haar-like features, the method comprising:
extracting, by a processor, the Haar-like features from an input image using Haar-like feature extraction algorithm, and detecting and recognizing objects of the input image based on the extracted Haar-like features,
the Haar-like feature extraction algorithm:
(a) selecting, by the processor, an origin of an input image and a location of a specific pixel; and
(b) raising to the n^{th} power, by the processor, all pixel values from the origin of the input image to the location of the specific pixel and creating the n^{th} integral image as a cumulative sum.

8. The method of claim 4, wherein the step (b) further comprises creating the n^{th} integral image based on the following equation:
$${I}^{( n )} ( x , y ) ≡ {\sum }_{i = 0}^{x} {\sum }_{j = 0}^{y} {( f ( i , j ) )}^{n} ,$$
where I⁽ⁿ⁾(x, y) is the n^{th} integral image, and f(i, j) is a pixel value of coordinates (i, j).

9. A method for detecting and recognizing objects of an image using Haar-like features, the method comprising:
extracting, by a processor, the Haar-like features from an input image using Haar-like feature extraction algorithm, and detecting and recognizing objects of the input image based on the extracted Haar-like features,
the Haar-like feature extraction algorithm:
(a) raising to the n^{th} power a pixel value at current coordinates of an input image;
(b) calculating a horizontal cumulative sum for the current coordinates by cumulating the n^{th} power of the pixel value at the current coordinates in a horizontal direction;
(c) creating the n^{th} integral image as a cumulative sum in horizontal and vertical directions by cumulating the horizontal cumulative sum in a vertical direction; and
(d) creating the n^{th} integral image for all coordinates by repeatedly performing the steps (a), (b) and (c) while sequentially moving the current coordinates from the origin in the horizontal and vertical directions.

10. The method of claim 9, wherein the step (b) further comprises calculating the horizontal cumulative sum based on the following equation:
i_{y}⁽ⁿ⁾(x,y)=i_{y}⁽ⁿ⁾(x,y−1)+(f(x,y))ⁿ,
the step (c) further comprises creating the n^{th} integral image as a cumulative sum in horizontal and vertical directions based on the following equation:
I⁽ⁿ⁾(x,y)=I⁽ⁿ⁾(x−1,y)+i_{y}⁽ⁿ⁾(x,y)
where I⁽ⁿ⁾(x, y) is the n^{th} integral image, f(x, y) is a pixel value at coordinates (x, y),
$${i}_{y}^{( n )} ( x , y - 1 ) = {\sum }_{j = 0}^{y - 1} {( f ( x , y ) )}^{n}$$
is a sum of pixel values in a horizontal direction in the x^{th} column, and i_{y}⁽ⁿ⁾(x, −1)=0, I⁽ⁿ⁾(−1, y)=0.

11. A method detecting and recognizing objects of an image using Haar-like features, the method comprising:
extracting, by a processor, the Haar-like features from an input image using Haar-like feature extraction algorithm, and detecting and recognizing objects of the input image based on the extracted Haar-like features,
the Haar-like feature extraction algorithm:
(a) setting a block with four vertex coordinates in an input image;
(b) creating the n^{th} integral image for the four vertex coordinates; and
(c) calculating the n^{th} moment of the block based on a cumulative value of the four vertex coordinates of the n^{th} integral image.

12. The method of claim 11, wherein n is at least one of 1, 2, 3 and 4.

13. The method of claim 11, wherein the step (c) further comprises calculating the n^{th} moment of the block based on the following equation:
$$\begin{matrix}{m}_{Δ}^{( n )} = \frac{1}{( {x}_{2} - {x}_{1} ) ( {y}_{2} - {y}_{1} )} {\sum }_{i = {x}_{1}}^{{x}_{2}} {\sum }_{j = {y}_{1}}^{{y}_{2}} {( f ( i , j ) )}^{n} \\ = \frac{1}{( {x}_{2} - {x}_{1} ) ( {y}_{2} - {y}_{1} )} ( \begin{matrix}{I}^{( n )} ( {x}_{2} , {y}_{2} ) + {I}^{( n )} ( {x}_{1} , {y}_{1} ) - \\ ( {I}^{( n )} ( {x}_{2} , {y}_{1} ) + {I}^{( n )} ( {x}_{1} , {y}_{2} ) )\end{matrix} )\end{matrix}$$
where m_{Δ}⁽ⁿ⁾ is the n^{th} moment, and I⁽ⁿ⁾(x, y) is the n^{th} integral image of a pixel f(x, y).

14. A method detecting and recognizing objects of an image using Haar-like features, the method comprising:
extracting, by a processor, the Haar-like features from an input image using Haar-like feature extraction algorithm, and detecting and recognizing objects of the input image based on the extracted Haar-like features,
the Haar-like feature extraction algorithm:
(a) setting a block with four vertex coordinates in an input image;
(b) creating the integral image for each order equal to or smaller than n; and
(c) calculating the n^{th} central moment of the block based on a cumulative value of the four vertex coordinates of the integral image for each order equal to or smaller than n.

15. The method of claim 14, wherein the step (c) further comprises calculating the n^{th} central moment based on the following equation:
$${m\_c}_{Δ}^{( n )} = \frac{1}{( {x}_{2} - {x}_{1} ) ( {y}_{2} - {y}_{1} )} {\sum }_{i = {x}_{1}}^{{x}_{2}} {\sum }_{j = {y}_{1}}^{{y}_{2}} {( f ( i , j ) - {μ}_{Δ} )}^{n} , \\ where {μ}_{Δ} = \frac{1}{( {x}_{2} - {x}_{1} ) ( {y}_{2} - {y}_{1} )} {\sum }_{i = {x}_{1}}^{{x}_{2}} {\sum }_{j = {y}_{1}}^{{y}_{2}} f ( i , j ) .$$

16. The method of claim 15, wherein n is 2, and the 2^{nd} central moment is calculated using the 1^{st} integral image and the 2^{nd} integral image by the following equation:
m_{—}c_{Δ}⁽²⁾=m_{Δ}⁽²⁾−(m_{Δ}⁽¹⁾)²≡σ_{Δ}²,
where
$${m}_{Δ}^{( 1 )} = \frac{1}{( {x}_{2} - {x}_{1} ) ( {y}_{2} - {y}_{1} )} ( {I}^{( 1 )} ( {x}_{2} , {y}_{2} ) + {I}^{( 1 )} ( {x}_{1} , {y}_{1} ) - ( {I}^{( 1 )} ( {x}_{2} , {y}_{1} ) + {I}^{( 1 )} ( {x}_{1} , {y}_{2} ) ) )$$
$${m}_{Δ}^{( 2 )} = \frac{1}{( {x}_{2} - {x}_{1} ) ( {y}_{2} - {y}_{1} )} ( {I}^{( 2 )} ( {x}_{2} , {y}_{2} ) + {I}^{( 2 )} ( {x}_{1} , {y}_{1} ) - ( {I}^{( 2 )} ( {x}_{2} , {y}_{1} ) + {I}^{( 2 )} ( {x}_{1} , {y}_{2} ) ) ) .$$

17. The method of claim 15, wherein n is 3, and the 3^{rd} central moment is calculated using the 1^{st} integral image, the 2^{nd} integral image and the 3^{rd} integral image by the following equation:
m_{—}c_{Δ}⁽³⁾=m_{Δ}⁽³⁾−3m_{Δ}⁽¹⁾m_{Δ}⁽²⁾+2(m_{Δ}⁽¹⁾)³,
where
$${m}_{Δ}^{( 1 )} = \frac{1}{( {x}_{2} - {x}_{1} ) ( {y}_{2} - {y}_{1} )} ( {I}^{( 1 )} ( {x}_{2} , {y}_{2} ) + {I}^{( 1 )} ( {x}_{1} , {y}_{1} ) - ( {I}^{( 1 )} ( {x}_{2} , {y}_{1} ) + {I}^{( 1 )} ( {x}_{1} , {y}_{2} ) ) )$$
$${m}_{Δ}^{( 2 )} = \frac{1}{( {x}_{2} - {x}_{1} ) ( {y}_{2} - {y}_{1} )} ( {I}^{( 2 )} ( {x}_{2} , {y}_{2} ) + {I}^{( 2 )} ( {x}_{1} , {y}_{1} ) - ( {I}^{( 2 )} ( {x}_{2} , {y}_{1} ) + {I}^{( 2 )} ( {x}_{1} , {y}_{2} ) ) )$$
$${m}_{Δ}^{( 3 )} = \frac{1}{( {x}_{2} - {x}_{1} ) ( {y}_{2} - {y}_{1} )} ( {I}^{( 3 )} ( {x}_{2} , {y}_{2} ) + {I}^{( 3 )} ( {x}_{1} , {y}_{1} ) - ( {I}^{( 3 )} ( {x}_{2} , {y}_{1} ) + {I}^{( 3 )} ( {x}_{1} , {y}_{2} ) ) ) .$$

18. The method of claim 15, wherein n is 4, and the 4^{th} central moment is calculated using the 1^{st} integral image, the 2^{nd} integral image, the 3^{rd} integral image and the 4^{th} integral image by the following equation:
m_{—}c_{Δ}⁽⁴⁾=m_{Δ}⁽⁴⁾−4m_{Δ}⁽³⁾m_{Δ}⁽¹⁾+6m_{Δ}⁽²⁾(m_{Δ}⁽¹⁾)²−3(m_{Δ}⁽¹⁾)⁴,
where
$${m}_{Δ}^{( 1 )} = \frac{1}{( {x}_{2} - {x}_{1} ) ( {y}_{2} - {y}_{1} )} ( {I}^{( 1 )} ( {x}_{2} , {y}_{2} ) + {I}^{( 1 )} ( {x}_{1} , {y}_{1} ) - ( {I}^{( 1 )} ( {x}_{2} , {y}_{1} ) + {I}^{( 1 )} ( {x}_{1} , {y}_{2} ) ) )$$
$${m}_{Δ}^{( 2 )} = \frac{1}{( {x}_{2} - {x}_{1} ) ( {y}_{2} - {y}_{1} )} ( {I}^{( 2 )} ( {x}_{2} , {y}_{2} ) + {I}^{( 2 )} ( {x}_{1} , {y}_{1} ) - ( {I}^{( 2 )} ( {x}_{2} , {y}_{1} ) + {I}^{( 2 )} ( {x}_{1} , {y}_{2} ) ) )$$
$${m}_{Δ}^{( 3 )} = \frac{1}{( {x}_{2} - {x}_{1} ) ( {y}_{2} - {y}_{1} )} ( {I}^{( 3 )} ( {x}_{2} , {y}_{2} ) + {I}^{( 3 )} ( {x}_{1} , {y}_{1} ) - ( {I}^{( 3 )} ( {x}_{2} , {y}_{1} ) + {I}^{( 3 )} ( {x}_{1} , {y}_{2} ) ) )$$
$${m}_{Δ}^{( 4 )} = \frac{1}{( {x}_{2} - {x}_{1} ) ( {y}_{2} - {y}_{1} )} ( {I}^{( 4 )} ( {x}_{2} , {y}_{2} ) + {I}^{( 4 )} ( {x}_{1} , {y}_{1} ) - ( {I}^{( 4 )} ( {x}_{2} , {y}_{1} ) + {I}^{( 4 )} ( {x}_{1} , {y}_{2} ) ) ) .$$

19. A non-transitory computer readable medium containing program instructions executed by a processor or controller, the computer readable medium comprising:
program instructions that extract the Haar-like features from an input image using Haar-like feature extraction algorithm, and detecting and recognizing objects of the input image based on the extracted Haar-like features,
the Haar-like feature extraction algorithm:
(a) applying, by the processor, a mask to an input image; and
(b) calculating, by the processor, the n^{th} moment of pixel values in each region to which the mask is applied and extracting a Haar-like feature based on a difference in the n^{th} moment between adjacent regions.
